(19) United States
(12) Patent Application Publication
(10) Pub. No.: US 2020/0403995 A1
(43) Pub. Date: Dec. 24, 2020

(54) INFORMATION PROCESSING SYSTEM, AND DEVICE

(71) Applicant: KONICA MINOLTA, INC., Tokyo (JP)

(72) Inventor: Harsh ANKUR, Tokyo (JP)

(73) Assignee: KONICA MINOLTA, INC., Tokyo (JP)

(21) Appl. No.: 16/897,404

(22) Filed: Jun. 10, 2020

(30) Foreign Application Priority Data
Jun. 18, 2019 (JP) 2019-112757

(51) Int. Cl. H04L 29/06; G10L 15/22; H04L 29/08

(52) U.S. Cl. CPC H04L 63/0884; H04L 67/146; G10L 15/22; H04L 63/0876

(57) ABSTRACT

An information processing system includes a first device, a second device, and a management device that is capable of communicating with each of the first device and the second device. The first device converts a generated authentication code into an acoustic signal and outputs the acoustic signal from a speaker and sends the authentication code to the management device. The second device extracts an authentication code from the acoustic signal acquired by a microphone and sends the authentication code to the management device. The management device collates the authentication code received from the first device and the authentication code received from the second device and, if the authentication codes are identical with each other, establishes communication between the first device and the second device.

### CROSS REFERENCE TO RELATED APPLICATIONS

The entire disclosure of Japanese Patent Application No. 2019-112757 filed on Jun. 18, 2019 is incorporated herein by reference in its entirety.

### BACKGROUND

### Technological Field

The present disclosure relates to an information processing system, a method for controlling an information processing system, a device, and a control program.

### Description of Related Art

Various information processing systems have been known in the related art. The information processing systems establish a communication connection between two devices to work in cooperation with each other.

One example of this type of information processing system is described in U.S. Patent Application Publication No. 2013/237155.

In this type of information processing system, from the viewpoint of security protection, an authentication process is required for establishing communication between two devices.

For example, U.S. Patent Application Publication No. 2013/237155 describes an authentication process performed by displaying an authentication code on each of the two devices and facing the two devices to each other to read each other's authentication code. Although this authentication process method is advantageous in performing an authentication process simply while protecting security, it lacks convenience because two devices need to be aligned.

### SUMMARY

The present disclosure is directed to an information processing system, a method for controlling an information processing system, a device, and a control program that enables an authentication process for establishing communication between two devices by a simpler method.

To achieve at least one of the abovementioned objects, according to an aspect of the present invention, an information processing system reflecting one aspect of the present invention, comprises:
a first device;
a second device; and
a management device that is capable of communicating with each of the first device and the second device,
wherein the first device includes
   a speaker, and
   a first controller that generates a first authentication code based on identification (ID) information of the first device, converts the first authentication code into an acoustic signal and outputs the acoustic signal from the speaker, and sends the first authentication code to the management device,
wherein the second device includes
   a microphone, and
   a second controller that causes the microphone to acquire the acoustic signal, extracts a second authentication code from the acquired acoustic signal, and sends the extracted second authentication code to the management device, and
wherein the management device includes a third controller that receives the first authentication code, receives the second authentication code, and collates the first authentication code and the second authentication code and, when the first authentication code is identical with the second authentication code, establishes communication between the first device and the second device.

To achieve at least one of the abovementioned objects, according to another aspect of the present invention, a device reflecting one aspect of the present invention comprises:
a speaker, and
a controller,
wherein the controller generates an authentication code based on ID information of the device, converts the authentication code into an acoustic signal and outputs from the speaker the acoustic signal to be acquired by a microphone of another device, sends the authentication code to a management device for establishing communication with the other device, and receives information of a voice command acquired by the microphone of the other device via the management device and executes an operation corresponding to the voice command

To achieve at least one of the abovementioned objects, according to another aspect of the present invention, a device reflecting one aspect of the present invention comprises:
a microphone, and
a controller,
wherein the controller causes the microphone to acquire an acoustic signal that is output from another device, extracts an authentication code from the acquired acoustic signal, sends the extracted authentication code to a management device for establishing communication with the other device, and sends information of a voice command acquired by the microphone to the management device to send the information to the other device via the management device.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an example of an overall configuration of an information processing system according to an embodiment;

FIG. 2 illustrates an example of a hardware configuration of a first device and a second device according to the embodiment;

FIG. 3 illustrates an example of a detailed configuration of the first device according to the embodiment;

FIG. 4 illustrates an example of a detailed configuration of the second device according to the embodiment;

FIG. 5 illustrates an example of a detailed configuration of a sever according to the embodiment;

FIG. 6 illustrates the entire flow of an authentication process for establishing communication between the first device and the second device in the information processing system according to the embodiment; and

FIG. 7 illustrates an example of a configuration for implementing information processing performed after establishing communication between the first device and the second device in the information processing system according to the embodiment.

### DETAILED DESCRIPTION OF EMBODIMENTS

Hereinafter, one or more embodiments of the present invention will be described with reference to the drawings. However, the scope of the invention is not limited to the disclosed embodiments.

### Background of the Disclosure

In the progress of the information processing technology and the speech recognition technology in recent years, information has been input by using sound in various fields. In this background, the present inventors have studied operations of a device with a voice command that is input from a user to a microphone.

However, depending on the device, the performance of the microphone provided for the device is not high, and an input operation with a voice command may cause an erroneous operation of the device. In addition, depending on the device, in terms of security or overuse of memory, it is not preferable for the device to set the microphone in an on state constantly.

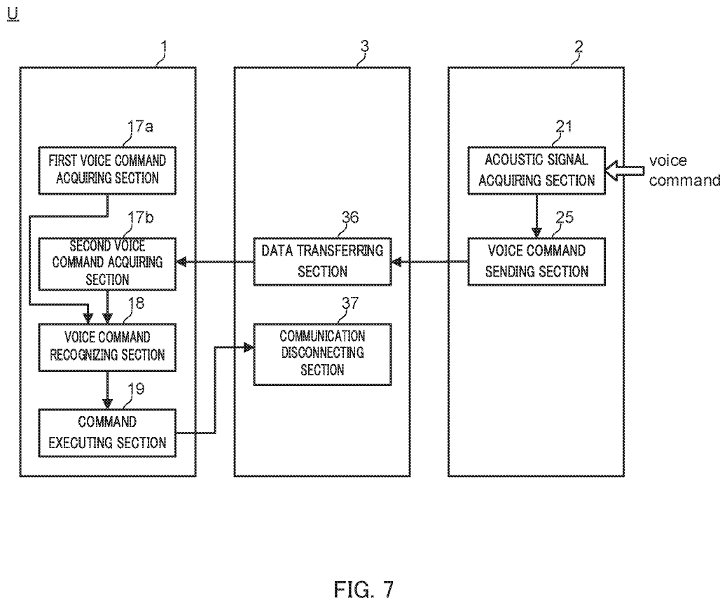

Accordingly, the present inventors have arrived at the present disclosure (described later with reference to FIG. 7). In the present disclosure, a user-friendly information processing system is established by causing a first device to operate by using a second device having a high-performance microphone as a user interface (i.e., sound input device).

However, as described above, it is also an important issue for the above information processing system to employ an authentication process method for establishing communication between two devices by a simple method while security is highly protected. Considering the configuration of the information processing system, the present inventors have intensely studied how to achieve a simple authentication process and arrived at the configuration of the present disclosure.

### Overall Configuration

The configuration of information processing system U according to an embodiment will be described below.

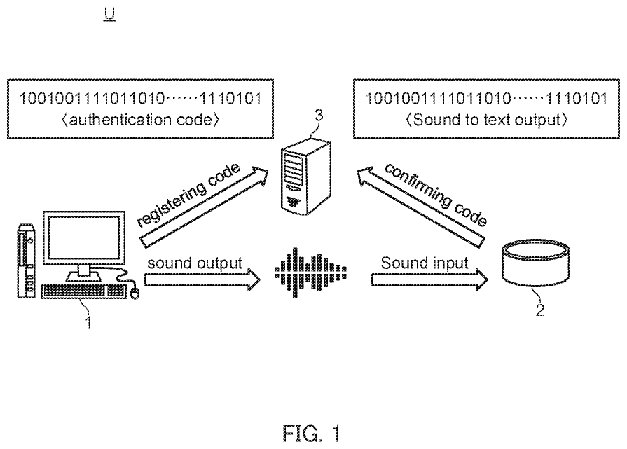

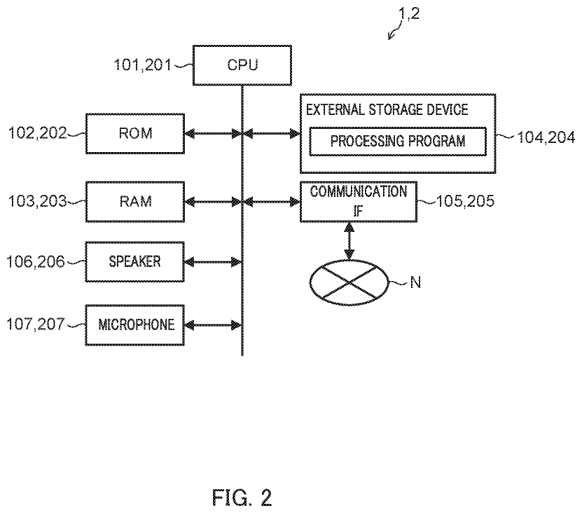

FIG. 1 illustrates an example of an overall configuration of information processing system U according to this embodiment. FIG. 2 illustrates an example of a hardware configuration of first device 1 and second device 2 according to this embodiment.

Information processing system U includes first device 1, second device 2, and sever 3 (corresponding to “management device” in the present disclosure). In information processing system U, sever 3 is connected to each of first device 1 and second device 2 via communication line N (not illustrated in FIG. 1).

Note that communication line N that establishes a communication connection between these devices is, for example, a local area network (LAN), a wide area network (WAN), an Internet line, or the like.

Information processing system U, for example, causes first device 1 to operate by using second device 2 as a user interface for sound input. In this case, communication between first device 1 and second device 2 is performed via sever 3. In addition, communication between first device 1 and second device 2 is configured to be established after an authentication process is performed by sever 3.

First device 1 is, for example, a computer in which print job management software or workflow software is installed in order to send a print job to a printer, and second device 2 is, for example, a smart speaker (also referred to as artificial intelligence (AI) speaker). The print job management software or the workflow software may be implemented as a web application. However, any type of device can be used as first device 1 and second device 2. First device 1 may be, for example, a home appliance such as a television, an air conditioner, or a lighting device, or may be a printer, a copier, or a multifunction peripheral (MFP) that executes a print job. In addition, second device 2 may be, for example, a smartphone or the like. Typically, microphone 207 of second device 2 preferably has a higher performance than microphone 107 of first device 1.

In this embodiment, as an example, first device 1 is a computer including as main components, as illustrated in FIG. 2, central processing unit (CPU) 101, read-only memory (ROM) 102, random access memory (RAM) 103, external storage device (e.g., flash memory) 104, communication interface 105, speaker 106, and microphone 107. The functions of the first device 1 described later are implemented by, for example, CPU 101 referring to a processing program or various kinds of data stored in ROM 102, RAM 103, external storage device 104, and the like. It is needless to say that part or all of the functions of first device 1 may also be implemented as an application specific integrated circuit (ASIC), a field-programmable gate array (FPGA), a digital signal processor (DSP), or the like.

Second device 2 has substantially the same configuration as first device 1 and includes, for example, CPU 201, ROM 202, RAM 203, external storage device 204, communication interface 205, speaker 206, and microphone 207.

Although omitted from the illustration, a plurality of devices other than first device 1 and second device 2 are also connected to sever 3 to perform communication, and sever 3 relays communication therebetween.

### First Device

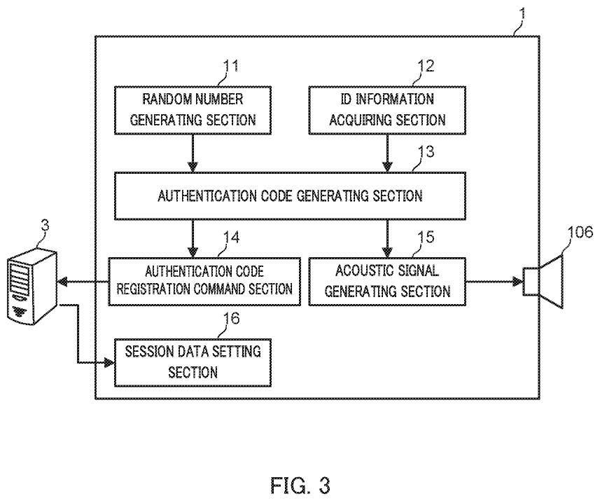

FIG. 3 illustrates an example of a detailed configuration of first device 1 according to this embodiment.

First device 1 includes random number generating section 11, identification (ID) information acquiring section 12, authentication code generating section 13, authentication code registration command section 14, acoustic signal generating section 15, and session data setting section 16. These functions of first device 1 are implemented as, for example, a web application that runs on first device 1. Note that random number generating section 11, ID information acquiring section 12, authentication code generating section 13, authentication code registration command section 14, acoustic signal generating section 15, and session data setting section 16 correspond to “first controller” in the present disclosure.

Random number generating section 11 generates a random number. The method for generating a random number by random number generating section 11 may be any known method, and is, for example, a method using a pseudo random number generating algorithm, such as a middle-square method, a linear congruential method, or a linear feedback shift register method. Note that the random number generated by random number generating section 11 is stored in a web application cookie, for example.

ID information acquiring section 12 acquires ID information of first device 1. The ID information of first device 1 is used for generating an authentication code and may be any information unique to first device 1. An example of the ID information of first device 1 is the internet protocol (IP) address of first device 1. However, for higher security, it is desirable to use, as the ID information of first device 1, in addition to the IP address, an operating system of first device 1 and its version information, a browser name of the web application of first device 1 and its version information, or the like.

Authentication code generating section 13 generates an authentication code on the basis of the random number generated by random number generating section 11 and the ID information of first device 1 acquired by ID information acquiring section 12. Authentication code generating section 13, for example, generates the authentication code from the random number and the ID information by using any known encryption algorithm.

Note that the authentication code generated by authentication code generating section 13 is typically a fixed-length authentication code.

Authentication code registration command section 14 sends the authentication code generated by authentication code generating section 13 to sever 3 together with an authentication code registration request. Thus, the authentication code generated by first device 1 is registered in sever 3.

Acoustic signal generating section 15 converts the authentication code generated by authentication code generating section 13 into an acoustic signal by using a predetermined algorithm defined in advance. Acoustic signal generating section 15 then converts the acoustic signal from a digital signal into an analog signal and outputs it as a sound wave from speaker 106 of first device 1. Note that an electric/electronic signal treated in first device 1 or second device 2 is referred to as acoustic signal in this embodiment. Also, a sound wave output from the speaker on the basis of the electric/electronic signal may also be referred to as acoustic signal, or may be simply referred to as sound wave.

Note that acoustic signal generating section 15 may use any algorithm when converting an authentication code into an acoustic signal. For example, on the basis of the authentication code, acoustic signal generating section 15 generates a frequency-modulated acoustic signal.

In this case, in order not to give an unpleasant feeling to a user, acoustic signal generating section 15 desirably uses an ultrasound acoustic signal, which is beyond human hearing.

Note that acoustic signal generating section 15 desirably outputs an acoustic signal related to a predetermined wake word for starting a predetermined function in second device 2 before speaker 106 outputs the acoustic signal related to the authentication code.

Session data setting section 16 receives a communication establishment report from sever 3 and then sets session data for enabling acquisition of a command (voice command) input to second device 2 by using voice via sever 3.

Note that first device 1 according to this embodiment is configured to operate in accordance with a voice command input to microphone 107 when communication with second device 2 is not established. Once communication with second device 2 is established, first device 1 acquires a voice command input to microphone 207 of second device 2 via sever 3 and operates in accordance with the voice command (described later with reference to FIG. 7).

### Second Device

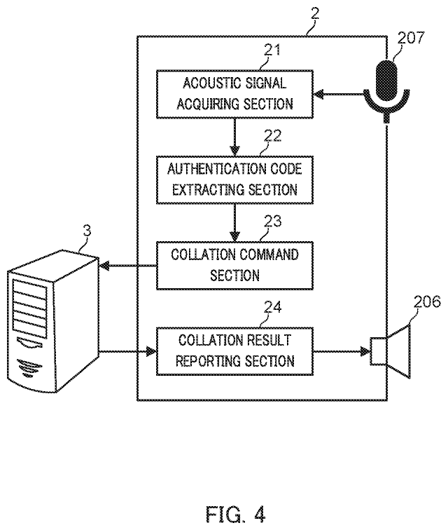

FIG. 4 illustrates an example of a detailed configuration of second device 2 according to this embodiment.

Second device 2 includes acoustic signal acquiring section 21, authentication code extracting section 22, collation command section 23, and collation result reporting section 24. These functions of second device 2 are implemented as, for example, a web application that runs on second device 2. Note that acoustic signal acquiring section 21, authentication code extracting section 22, collation command section 23, and collation result reporting section 24 correspond to “second controller” in the present disclosure.

Acoustic signal acquiring section 21 acquires an acoustic signal (sound wave) output from first device 1 by using microphone 207 of second device 2. Acoustic signal acquiring section 21, for example, converts an electric signal (analog signal) generated on the basis of the sound wave received by microphone 207 from an analog signal into a digital signal and stores it in RAM 203 or the like of second device 2.

When acquiring the acoustic signal (sound wave) from first device 1, second device 2 is desirably placed in the proximity of first device 1. However, it suffices to be within the same room as first device 1.

Authentication code extracting section 22 extracts an authentication code from the acoustic signal by using an algorithm defined in advance. The algorithm used by authentication code extracting section 22 to convert an acoustic signal into an authentication code is the inverse conversion algorithm corresponding to the algorithm by which acoustic signal generating section 15 of first device 1 converts an authentication code into an acoustic signal.

Note that authentication code extracting section 22 may be configured to extract an authentication code only when an acoustic signal input to acoustic signal acquiring section 21 is an ultrasonic acoustic signal (i.e., frequency band for authentication code).

Collation command section 23 sends the authentication code extracted by authentication code extracting section 22 to sever 3 together with a collation command That is, collation command section 23 causes sever 3 to perform a collation process as to whether the authentication code extracted by authentication code extracting section 22 is identical with the authentication code generated in first device 1.

Collation result reporting section 24 receives a report related to the collation process from sever 3 and audibly outputs the report (authentication success or authentication failure) from speaker 206.

Second device 2 according to this embodiment is, for example, configured to send to sever 3 a voice command input through microphone 207 regardless of authentication success or failure for first device 1. Thus, when second device 2 according to this embodiment is authenticated successfully and is to serve as a user interface (i.e., sound input device) of first device 1, second device 2 can operate as a sound input device for first device 1 without particularly changing settings.

In addition, second device 2 according to this embodiment is, for example, further configured to be capable of speech recognition of at least a wake word even in sleep state. Thus, in response to sound of a wake word being input, second device 2 changes the operation mode from sleep state to be activated to accept a voice command

### Sever

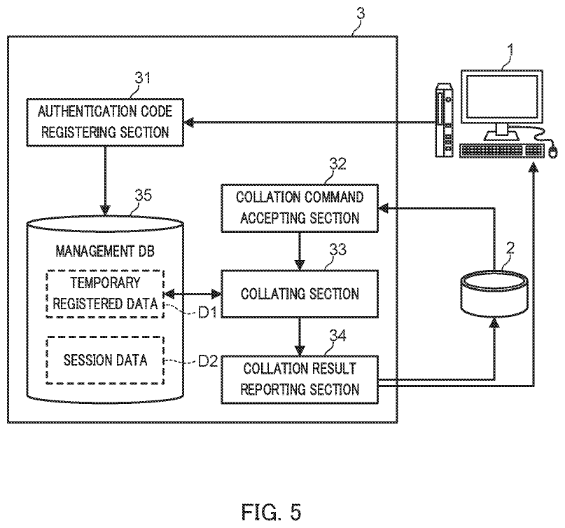

FIG. 5 illustrates an example of a detailed configuration of sever 3 according to this embodiment.

Sever 3 includes authentication code registering section 31, collation command accepting section 32, collating section 33, and collation result reporting section 34. These functions of sever 3 are implemented as, for example, an HTTP server program that runs on sever 3. Note that authentication code registering section 31, collation command accepting section 32, collating section 33, and collation result reporting section 34 correspond to “third controller” in the present disclosure.

Sever 3 further includes management database (DB) 35 that stores temporary registered data D1 and session data D2. As temporary registered data D1, the authentication code received from first device 1 is registered. Session data D2 is used for establishing communication between first device 1 and second device 2 when authentication between first device 1 and second device 2 is successful.

Authentication code registering section 31 accepts an authentication code registration request from first device 1 (authentication code registration command section 14) and, in response to this registration request, registers the authentication code received from first device 1 in temporary registered data D1. Note that the authentication code registered in authentication code registering section 31 is stored temporarily and is discarded after a certain period has passed.

The authentication code received from first device 1 herein may typically be registered as the ID information of first device 1 by using a decryption algorithm corresponding to the encryption algorithm used when first device 1 (authentication code generating section 13) generates the authentication code.

Collation command accepting section 32 accepts a collation command from second device 2 (collation command section 23).

In response to the collation command from second device 2, collating section 33 performs a collation process as to whether the authentication code received from second device 2 is registered in temporary registered data D1. That is, collating section 33 performs a collation process as to whether the authentication code received from second device 2 is identical with the authentication code received from first device 1.

If the authentication code received from second device 2 is identical with the authentication code of first device 1 registered in temporary registered data D1, collating section 33 determines authentication success and registers session data D2 for establishing communication between first device 1 and second device 2 in management DB 35. Note that session data D2 includes, for example, data such as the IP address of first device 1, the IP address of second device 2, or data indicating first device 1 or second device 2 as a device to be used as a user interface.

On the other hand, if the authentication code received from second device 2 is not identical with the authentication code of first device 1 registered in temporary registered data D1, collating section 33 determines authentication failure.

Collation result reporting section 34 reports the result of collation (i.e., result indicating authentication success or authentication failure) performed by collating section 33 to each of first device 1 and second device 2.

### Authentication Process Flow

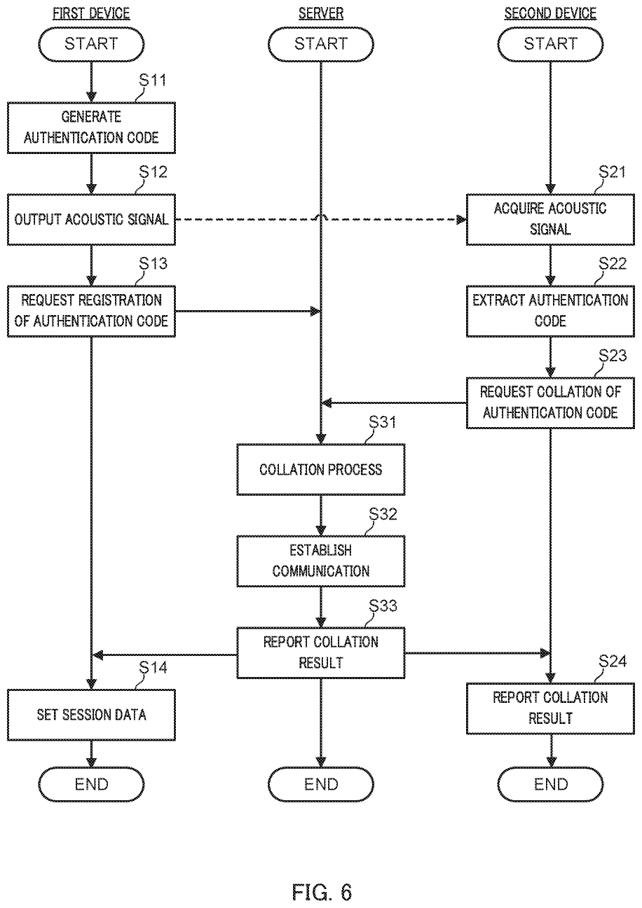

FIG. 6 illustrates the entire flow of an authentication process for establishing communication between first device 1 and second device 2 in information processing system U according to this embodiment.

First, on the basis of a random number and the ID information of first device 1, first device 1 generates an authentication code (step S11). Then, first device 1 converts the authentication code into an acoustic signal and outputs the acoustic signal from speaker 106 (step S12). Subsequently, first device 1 sends the generated authentication code to sever 3 together with an authentication code registration request to cause sever 3 to register the authentication code (step S13).

Second device 2 acquires the acoustic signal output from first device 1 through microphone 207. At this time, second device 2 is activated by a wake-up acoustic signal output from first device 1 and then acquires the acoustic signal for the authentication code output from first device 1 (step S21). Then, second device 2 extracts the authentication code from the acoustic signal (step S22). Subsequently, second device 2 sends the extracted authentication code to sever 3 and requests collation of the authentication code (step S23).

Upon receipt of the authentication code collation request from second device 2, sever 3 collates the authentication code received from first device 1 with the authentication code received from second device 2 (step S31). Then, if the authentication code received from first device 1 is identical with the authentication code received from second device 2, sever 3 establishes communication between first device 1 and second device 2 (step S32). Then, sever 3 reports the collation result to each of first device 1 and second device 2 (step S33).

Then, in response to receipt of the collation result (authentication success in this example) from sever 3, first device 1 sets session data for enabling acquisition of a voice command input to second device 2 via sever 3 (step S14). In addition, second device 2 reports the collation result from speaker 206 (step S24).

Through the above flow, the authentication process for establishing communication between first device 1 and second device 2 is performed.

### Information Processing Flow

FIG. 7 illustrates an example of a configuration for implementing information processing performed after establishing communication between first device 1 and second device 2 in information processing system U according to this embodiment.

FIG. 7 illustrates an information processing flow by using arrows. Note that the configurations illustrated in FIGS. 3 to 5 are omitted from the illustration in FIG. 7.

First device 1 includes first voice command acquiring section 17a, second voice command acquiring section 17b, voice command recognizing section 18, and command executing section 19.

First voice command acquiring section 17a acquires a voice command input to microphone 107 provided for first device 1. Second voice command acquiring section 17b acquires a voice command input to second device 2 and transferred via sever 3. Note that at a stage before establishment of communication between first device 1 and second device 2 (i.e., before setting session data in session data setting section 16), first device 1 sets first voice command acquiring section 17a in an on state and second voice command acquiring section 17b in an off state. Then, after establishment of communication between first device 1 and second device 2 (i.e., after setting session data in session data setting section 16), first device 1 changes first voice command acquiring section 17a to an off state and second voice command acquiring section 17b to an on state.

Voice command recognizing section 18 performs a speech recognition process on the voice command acquired through first voice command acquiring section 17a or second voice command acquiring section 17b. For example, by referring to data (not illustrated) stored in external storage device 104, such as an acoustic model, a dictionary, and a language model, voice command recognizing section 18 analyzes a time-series voice feature of the voice command On the basis of the analyzed time-series voice feature of the voice command and a command list (not illustrated) stored in external storage device 104, voice command recognizing section 18 recognizes the voice command Note that although FIG. 7 illustrates an example in which first device 1 includes the voice command recognizing section, an external device (e.g., speech recognition service on the cloud) may have the function of the voice command recognizing section. In this case, first device 1 sends a voice command to the external device and receives a recognition result of the voice command from the external device.

In accordance with the voice command recognized by voice command recognizing section 18, command executing section 19 executes a process corresponding to the voice command (e.g., processing indicated by the command list stored in external storage device 104). Note that if the voice command designates disconnection of communication with second device 2, command executing section 19 sends this designation to sever 3 (communication disconnecting section 37).

Second device 2 includes acoustic signal acquiring section 21 and voice command sending section 25. By using microphone 207, acoustic signal acquiring section 21 acquires an acoustic signal output from first device 1. Voice command sending section 25 sends to sever 3 the voice command acquired through acoustic signal acquiring section 21.

Sever 3 includes data transferring section 36 and communication disconnecting section 37.

When a voice command is received from second device 2, data transferring section 36 refers to session data D2 in management DB 35 to determine whether a device for communication connection with second device 2 is present. If it is determined that first device 1 is present as a device for communication connection with second device 2, data transferring section 36 transfers to first device 1 the voice command received from second device 2.

If a communication disconnection command is received from command executing section 19 of first device 1, communication disconnecting section 37 discards session data D2 in management DB 35 and disconnects communication between first device 1 and second device 2.

After establishment of communication between first device 1 and second device 2, upon a voice command being input to second device 2, information processing system U according to this embodiment causes first device 1 to operate in an event-driven manner. Note that this operation is implemented as a webhook (or Reverse application programming interface (API)).

Thus, first device 1 can operate by using second device 2 having a high-performance microphone as a user interface.

### Effects

In the above manner, information processing system U according to this embodiment can perform an authentication process for establishing communication between first device 1 and second device 2 by using speakers and microphones provided for the devices by a simple method with security being highly protected. In particular, information processing system U according to this embodiment is advantageous in being capable of performing the authentication process without aligning first device 1 and second device 2.

In addition, in information processing system U according to this embodiment, first device 1 and second device 2 are configured to operate with a web application. Thus, even a device not having a dedicated application can perform the authentication process with ease.

### Other Embodiments

The present disclosure is not limited to the above embodiment, and various modifications can be made.

The above embodiment has illustrated an example of information processing system U in which first device 1 has a speech recognition function. However, information processing system U in the present disclosure may also have a configuration in which second device 2 or sever 3 has a speech recognition function. In this case, first device 1 may operate with a voice command only when communication with second device 2 is established.

In addition, the above embodiment has illustrated an example of second device 2 that sends to sever 3 all voice commands that are input through microphone 207 regardless of whether communication with first device 1 is established. However, second device 2 in the present disclosure may operate alone on the basis of a voice command input through microphone 207 under normal conditions (i.e., before establishing communication with first device 1). In this case, if the result of the authentication process performed in sever 3 is authentication success, second device 2 sets session data, and if a voice command is input through microphone 207 of second device 2, second device 2 may change the setting to send the voice command to sever 3.

Although embodiments of the present invention have been described and illustrated in detail, the disclosed embodiments are made for purpose of illustration and example only and not limitation. The scope of the present invention should be interpreted by terms of the appended claims.

An information processing system according to the present disclosure enables an authentication process for establishing communication between two devices by a simpler method.

What is claimed is:

1. An information processing system, comprising:
a first device;
a second device; and
a management device that is capable of communicating with each of the first device and the second device,
wherein the first device includes
a speaker, and
a first controller that generates a first authentication code based on identification (ID) information of the first device, converts the first authentication code into an acoustic signal and outputs the acoustic signal from the speaker, and sends the first authentication code to the management device,
wherein the second device includes
a microphone, and
a second controller that causes the microphone to acquire the acoustic signal, extracts a second authentication code from the acquired acoustic signal, and sends the extracted second authentication code to the management device, and
wherein the management device includes a third controller that receives the first authentication code, receives the second authentication code, and collates the first authentication code and the second authentication code and, when the first authentication code is identical with the second authentication code, establishes communication between the first device and the second device.

2. The information processing system according to claim 1,
wherein, when a voice command is acquired by the microphone, the second controller included in the second device sends information regarding the acquired voice command to the management device,
wherein the third controller included in the management device receives the information regarding the voice command sent from the second device and sends the information regarding the voice command to the first device, and
wherein the first controller included in the first device receives the information regarding the voice command sent from the management device and executes an operation corresponding to the voice command

3. The information processing system according to claim 1,
wherein the first controller generates a random number, and
the first controller generates, based on the generated random number and the ID information of the first device, the first authentication code.

4. The information processing system according to claim 1,
wherein an operation of the first device is implemented as a web application that runs on the first device.

5. The information processing system according to claim 1,
wherein, when communication with the second device is not established, the first device operates in accordance with a first voice command that is input to a microphone of the first device, and
wherein, when communication with the second device is established, the first device acquires via the management device, a second voice command that is input to the microphone of the second device, and operates in accordance with the second voice command

6. The information processing system according to claim 5,
wherein, when communication with the second device is established, upon the second voice command being input to the microphone of the second device, the first device operates in an event-driven manner.

7. The information processing system according to claim 5,
wherein, when the second voice command is a communication disconnection command, the management device disconnects the communication between the first device and the second device.

8. The information processing system according to claim 1,
wherein the acoustic signal is an ultrasound acoustic signal.

9. The information processing system according to claim 1,
wherein the ID information of the first device includes an internet protocol (IP) address of the first device.

10. The information processing system according to claim 4,
wherein the ID information of the first device includes a browser name of the web application and version information thereof.

11. The information processing system according to claim 4,
wherein a random number generated by the first device is stored in a cookie of the web application.

12. The information processing system according to claim 1,
wherein the first device is a printer.

13. The information processing system according to claim 1,
wherein the second device is a smart speaker.

14. A device comprising:
a speaker, and
a controller,
wherein the controller generates an authentication code based on ID information of the device, converts the authentication code into an acoustic signal and outputs from the speaker the acoustic signal to be acquired by a microphone of another device, sends the authentication code to a management device for establishing communication with the other device, and receives information of a voice command acquired by the microphone of the other device via the management device and executes an operation corresponding to the voice command

15. A device comprising:
a microphone, and
a controller,
wherein the controller causes the microphone to acquire an acoustic signal that is output from another device, extracts an authentication code from the acquired acoustic signal, sends the extracted authentication code to a management device for establishing communication with the other device, and sends information of a voice command acquired by the microphone to the management device to send the information to the other device via the management device.
